(19) United States
(12) Patent Application Publication
(10) Pub. No.: US 2024/0171488 A1
(43) Pub. Date: May 23, 2024

(54) MULTI-PORT MULTI-FUNCTION ENERGY METER

(71) Applicant: SCHNEIDER ELECTRIC USA, INC., Boston, MA (US)

(72) Inventors: Piotr Boleslaw Przydatek, Victoria (CA); Stewart John Harding, Victoria (CA); Marc Alan Ricci, Victoria (CA)

(21) Appl. No.: 18/058,460

(22) Filed: Nov. 23, 2022

(51) Int. Cl. H04L 43/08; H04L 12/10

(52) U.S. Cl. CPC H04L 43/08; H04L 12/10

(57) ABSTRACT

In one embodiment, a multi-function energy meter apparatus is described. The multi-function energy meter apparatus includes (a) measurement circuitry configured to measure one or more energy-related parameters; and (b) three independent ethernet ports communicatively coupled to the measurement circuitry, each independent ethernet port being configured to connect to a respective local area network (LAN) and to communicate the measured energy-related parameters to that LAN. A related system is also described.

### BACKGROUND

Energy meters are used to monitor and report energy usage. Some energy meters include a network connection to allow reporting of energy usage across a wide area network (WAN), such as the Internet. Some energy meters include a local bus port (e.g., a serial port) to connect to an expansion device that is configured to receive reports of energy usage from the energy meter and perform various functions such as data analysis and feedback, storage, and forwarding.

### SUMMARY

In one embodiment, a multi-function energy meter apparatus is described. The multi-function energy meter apparatus includes (a) measurement circuitry configured to measure one or more energy-related parameters; and (b) three independent ethernet ports communicatively coupled to the measurement circuitry, each independent ethernet port being configured to connect to a respective local area network (LAN) and to communicate the measured energy-related parameters to that LAN.

In one embodiment, a multi-function energy meter apparatus is described in which one of the three independent ethernet ports is configured to: (1) connect to an expansion device configured to add additional functionality to the energy meter apparatus; and (2) communicate information relating to the measured energy-related parameters to the expansion device. In one such embodiment, the multi-function energy meter apparatus further includes a local clock, and the one of the three independent ethernet ports is further configured to synchronize the local clock with a remote clock of the expansion device to a precision within 1 millisecond. In one embodiment, the one of the three independent ethernet ports is further configured to provide power to the energy meter apparatus over a Power over Ethernet (PoE) connection. In one embodiment, the multi-function energy meter apparatus is configured to send code to the expansion device, the code being configured to expand the additional functionality.

In one embodiment, a multi-function energy meter apparatus is described in which (1) the energy meter apparatus is configured to receive primary power via the measurement circuitry; and (2) one of the three independent ethernet ports is configured to receive power over a Power over Ethernet (PoE) connection and to provide the received power as backup power for the multi-function energy meter apparatus.

In one embodiment, a multi-function energy meter apparatus is described in which one of the three independent ethernet ports is configured to receive power over a Power over Ethernet (PoE) connection and to provide the received power as primary power for the multi-function energy meter apparatus.

In one embodiment, a multi-function energy meter apparatus is described in which communicating the measured energy-related parameters to that LAN includes sending the measured energy-related parameters to that LAN using data link layer (layer 2) communication.

In one embodiment, a system is described. The system includes (I) a multi-function energy meter apparatus comprising: (a) measurement circuitry configured to measure one or more energy-related parameters; and (b) three independent ethernet ports communicatively coupled to the measurement circuitry; and (II) three separate ethernet-based local area networks (LANs), each LAN communicatively coupled to a respective one of the three independent ethernet ports. Each independent ethernet port is configured to communicate the measured energy-related parameters to its respective LAN. In one embodiment, a system is described in which (1) the system further comprises an expansion device connected to one of the three independent ethernet ports via one of the ethernet-based LANs; (2) the expansion device is configured to add additional functionality to the energy meter apparatus; and (3) the one of the three independent ethernet ports is configured to communicate information relating to the measured energy-related parameters to the expansion device. In one such embodiment, the expansion device is further configured to: (A) receive a plurality of status input transitions from another device; and (B) timestamp each of the plurality of status input transitions with reference to the second clock. In one such embodiment, the one of the three independent ethernet ports is further configured to receive the plurality of timestamped status input transitions from the expansion device.

### BRIEF DESCRIPTION OF THE DRAWINGS

The foregoing and other objects, features, and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention. In the figures:

FIG. 1 illustrates an example system and apparatus for use in connection with one or more embodiments.

FIG. 2 illustrates an example system and apparatus for use in connection with one or more embodiments.

FIG. 3 illustrates an example system and apparatus for use in connection with one or more embodiments.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Conventional energy meters, as described, may suffer from various limitations. For example, multiple independent entities may require reporting of energy usage from the energy meter, and cybersecurity concerns may make it undesirable to transmit energy usage data across a WAN to an external entity. Even if a local area network (LAN) were to be used instead, security and logistical concerns may preclude sending energy usage data to multiple independent entities using a single LAN. Thus, conventional energy meters may not be able to provide reporting of energy usage to multiple independent entities in a secure manner.

As another example, connecting to an expansion device using a local bus port (e.g., a serial port) may not provide sufficient flexibility in terms of features. For example, an expansion device may timestamp energy usage data received from an energy meter or status input transitions. However, time synchronization across a local bus is often of poor quality with divergence as high as 100 milliseconds (ms).

As yet another example, conventional energy meters are often powered by the very energy source that they are monitoring. This may prevent reliable operation of the energy meter when the monitored energy source is fluctuating or offline.

Thus, it would be desirable for an improved energy meter to overcome these deficiencies. For example, an improved energy meter may provide three independent ethernet ports capable of connecting to three independent LANs simultaneously. In some embodiments, one or more of the three independent ethernet ports may connect to an expansion box via a LAN connection. This type of connection may be advantageous because the Precision Time Protocol may be used to synchronize time between the energy meter and the expansion device to a very high degree of precision with a divergence of less than 1 ms, for example. In some embodiments, one or more of the three independent ethernet ports may be configured to receive power via Power over Ethernet to allow for either primary or backup power, reducing the likelihood of unreliable operation of the energy meter when the monitored energy source is fluctuating or offline.

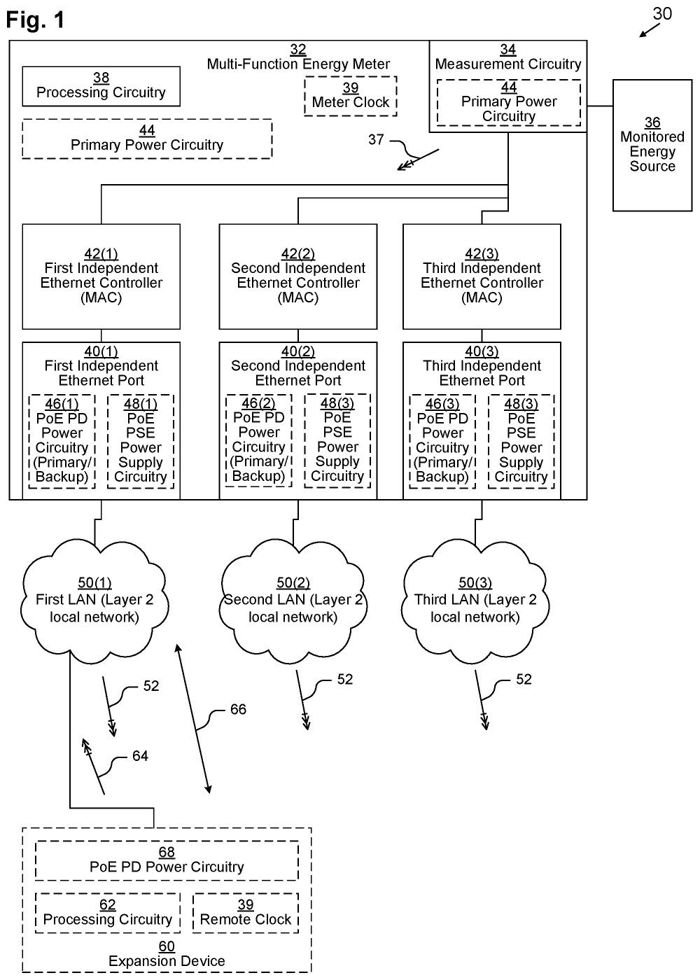

FIG. 1 depicts an example system 30 for use in connection with various embodiments. System 30 includes a multi-function energy meter (MFEM) 32, a monitored energy source 36, and one or more LANs 50 (depicted as LANs 50(1), 50(2), 50(3)). It should be understood that the term “LAN,” as used herein, refers to any network (e.g., Ethernet) connection between two or more devices that primarily relies on data link layer (i.e., layer 2) communication protocols. Thus, a point-to-point (PPP) connection between two devices using layer 2 networking protocols (e.g., PPP over Ethernet, PPPoE) is considered a LAN. A set of two or more devices that are all connected to a hub or layer 2 switch (without being interconnected using a router or layer 3 switch) may also be considered a LAN.

MFEM 32 includes measurement circuitry 34 for measuring energy-related parameters 37 from the monitored energy source 36, processing circuitry 38, three independent Ethernet controllers 42 (depicted as independent Ethernet controllers 42(1), 42(2), 42(3)), and three independent Ethernet ports 40 (depicted as independent Ethernet ports 40(1), 40(2), 40(3)). Independent Ethernet controllers 42 may each be media access controllers (MACs). In some embodiments, one or more of the ports 40 may be Fibre Channel or other Fiber Optic ports instead of Ethernet cable ports. In some embodiments, MFEM 32 may also include a meter clock 39. In some embodiments (not depicted), MFEM 32 may contain more than three independent Ethernet controllers 42.

Processing circuitry 38 may include any kind of processor or set of processors configured to perform operations, such as, for example, a microprocessor, a multi-core microprocessor, a central processing unit (CPU), a digital signal processor, a system on a chip (SoC), a collection of electronic circuits, a similar kind of controller, or any combination of the above. In an example embodiment, processing circuitry 38 may be a ZynQ UltraScale+(US+) MPSoC, such as a ZynQ US+ZU2CG chip provided by Xilinx/AMD of San Jose, California.

In some embodiments, MFEM 32 is powered by primary power circuitry 44, which obtains power from the monitored energy source 36. In some of these embodiments, in case the primary power circuitry 44 is not able to continuously obtain power from the monitored energy source 36, backup/secondary power may also be obtained from Power over Ethernet (PoE) Powered Device (PD) circuitry 46 receiving PoE power from a remote device connected to one of the independent Ethernet ports 40. Although PoE PD circuitry 46 is depicted within each of the independent Ethernet ports 40, typically at most one of these is configured to provide power to the MFEM 32 at any given time.

In other embodiments, MFEM 32 is powered by PoE PD circuitry 46 operating as primary power circuitry. In yet other embodiments, MFEM 32 is powered by primary power circuitry 44 plugged into an external non-monitored power source (e.g., 110V AC wall power).

In some embodiments, MFEM 32 provides PoE power to a remote device (e.g., an expansion device 60) via PoE PSE circuitry 48. Thus, for example, as depicted, an expansion device 60 having PoE PD circuitry 68 receives power from PoE Power Source Equipment (PSE) power supply circuitry 48(1) that is part of first independent ethernet port 40(1) to which the expansion device 60 is connected via first local area network (LAN) 50(1).

In operation, upon monitoring the monitored energy source 36, measurement circuitry 34 sends measured energy-related parameters 37 about the energy usage of the monitored energy source 36 to one or more of the independent Ethernet controllers 42. This may be performed periodically, e.g., every 1 second. Energy-related parameters 37 may include, for example, one or more of peak power, average power, power demand, voltage frequency, peak voltage, average voltage, peak current, average current, current demand, voltage/current harmonics, voltage/current unbalance, voltage sags/swell, voltage/current interruptions, etc.

Upon a particular independent Ethernet controller 42(X) receiving the measured energy-related parameters 37, that independent Ethernet controller 42(X) creates a message including information 52 relating to the measured energy-related parameters 37 and sends that information 52 across its associated LAN 50(X) via its associated independent Ethernet port 40(X). In some embodiments, the information 52 is sent via layer 2 communication protocols.

In some embodiments, one of the LANs 50 connects to a billing data collection system for a utility company. In some embodiments, one of the LANs 50 connects to a power quality monitoring system for a utility company. In some embodiments, one of the LANs 50 connects to a power monitoring system for a customer entity that is operating the MFEM 32. In some embodiments, one of the LANs 50 connects to a substation IEC61850 Process Bus.

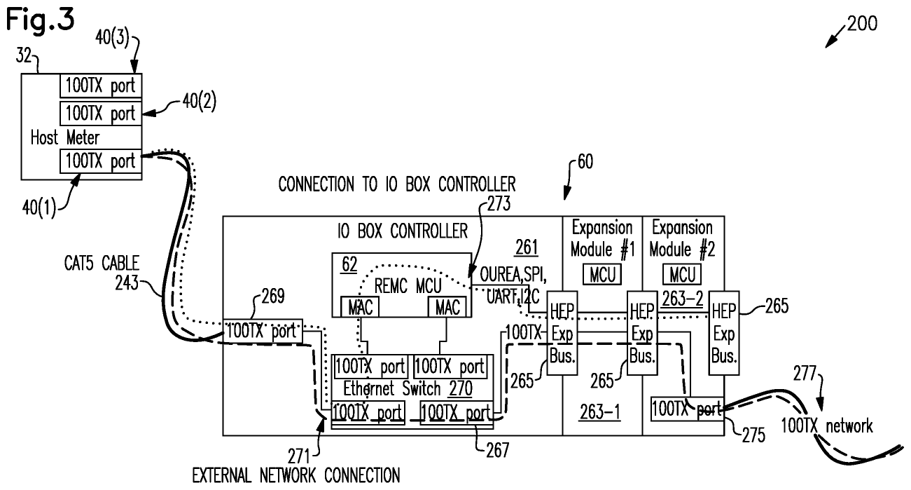

In some embodiments, MFEM 32 connects to an expansion device 60 via one of the independent Ethernet ports 40. Expansion device 60 may be configured to add additional functionality to the MFEM 32. In some embodiments, expansion device 60 may be made up of an expansion module controller that is configurable to be expanded with one or more optional expansion modules (see below in connection with FIG. 3). In some embodiments, one of the independent ethernet ports 40 may be configured such that it is only able to connect to a LAN 50 that is a PPP connection to a single remote device; thus, for example, ethernet port 40(1) may be configured such that first LAN 50(1) must operate as PPPoE, thereby providing a direct PPPoE connection to expansion device 60.

In some embodiments, upon receiving the information 52 relating to the measured energy-related parameters 37, processing circuitry 62 of the expansion device 60 (which may include general purpose or special purpose circuitry mounted on an expansion module) may process the received information 52 to generate data 64 that relates to the measured energy-related parameters 37. Expansion module 60 may then send that data 64 back to the MFEM 32 over the LAN 50 or it may send the data 64 to another device via another connection. In some embodiments, the data 64 may not relate directly to the measured energy-related parameters 37—for example, the data 64 may be based on status signals from hardware of the expansion module 60 or other connected equipment; the data 64 may be based on measurements (e.g., temperature readings) generated by hardware of the expansion module 60 or other connected equipment; the data 64 may be based on measured energy-related parameters received from one or more additional MFEMs aside from MFEM 32; or the data 64 may be based on a combination of these examples. In some embodiments, the MFEM 32 is configured to send code to the expansion module 60. This code may include a firmware update or a software update to be installed on the expansion module 60 in order to update or expand its functionality. This update may define either an operating system of the processing circuitry 62 of the expansion module 60 or other operation of the processing circuitry 62 of the expansion module 60 or an attached expansion module.

In some embodiments, in order to allow the MFEM 32 to be kept in synchronization with the expansion module 60, a time synchronization procedure 66 may be performed over the LAN 50 connecting the MFEM 32 to the expansion module 60. This time synchronization procedure 66 may allow a clock 39 of the MFEM 32 to be kept very closely synchronized to a clock 39 of the expansion module 60. In some embodiments, the Precision Time Protocol (IEEE 1588-2008 or 1588-2019) or a similar protocol may be used to achieve a synchronization that is precise to within 1 millisecond (ms). In some embodiments, the synchronization may be further precise to within 100 nanoseconds (ns). In some embodiments, expansion module 60 may timestamp transitions (such as status signal changes from other equipment, such as whether an external circuit breaker is open or closed) or energy usage data (such as energy data transmitted via energy pulse outputs of other equipment). The expansion module 60 can record the exact time of input transitions and then correlate them in time with power usage data, waveform recording, or other measurements performed by MFEM 32 for sequence of event recording (SER). The expansion module 60 can also receive digital pulse information from other MFEMs 32.

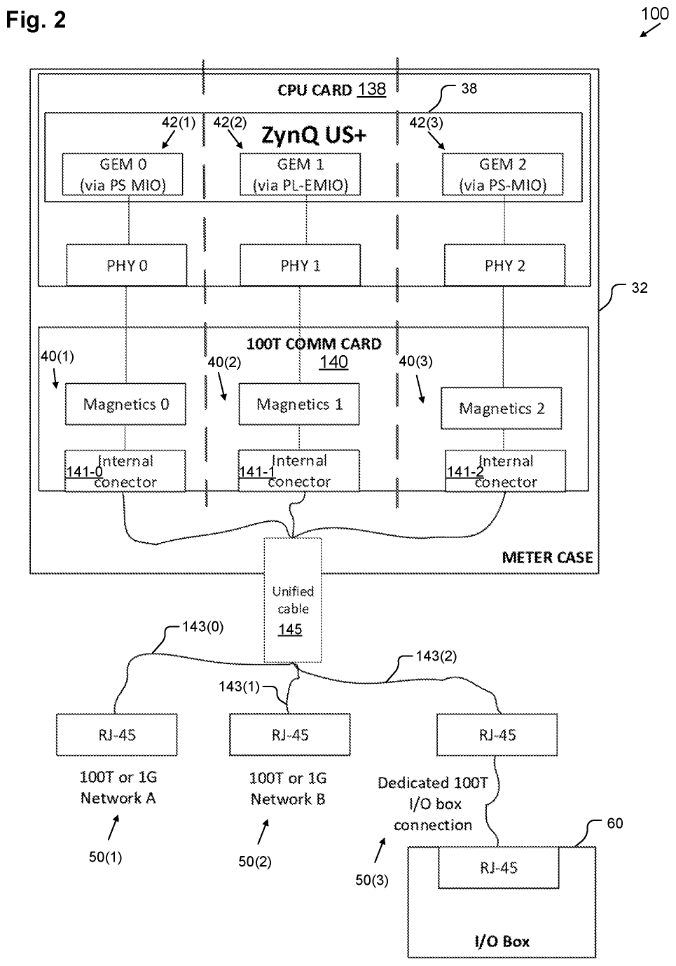

FIG. 2 depicts an environment 100 according to an embodiment. MFEM 32 is shown in a different view, omitting the measurement circuitry 34, clock 39, and power circuitry 44, 46, 48. As depicted in FIG. 2, processing circuitry 38 is implemented as a ZynQ US+ chip on a CPU card 138. As depicted, ZynQ US+ chip includes three Gigabit Ethernet Media Access Control (MAC) blocks GEM 0 42(1), GEM 1 42(2), GEM 2 42(3), each of which is connected to its own respective physical layer (PHY) circuitry or chip PHY 0, PHY 1, PHY 2.

As depicted in FIG. 2, independent ethernet ports 40 are implemented on a single Ethernet card 140. On Ethernet card 140, the first independent ethernet port 40(1) includes magnetics 0 and internal connector 141-0; the second independent ethernet port 40(2) includes magnetics 1 and internal connector 141-1; and the third independent ethernet port 40(3) includes magnetics 2 and internal connector 141-2.

As depicted in FIG. 2, Ethernet cables 143(0), 143(1), 143(2) for each respective independent internal connector 141-0, 141-1, 141-2 are joined together into a unified cable 145 to make cable management easier. In this arrangement, each Ethernet cable 143 terminates in an RJ-45 jack, and Ethernet cable 143(2) connects to an I/O box, which is an embodiment of expansion device 60. In the environment of FIG. 2, expansion device 60 connects to LAN 50(3) rather than to LAN 50(1) as in FIG. 1.

FIG. 3 depicts an environment 100 according to an embodiment. MFEM 32 is shown in a different view, omitting all internal elements other than the independent Ethernet ports 40. As depicted in FIG. 3, Ethernet cable 243 (e.g., CatS cable) connects independent Ethernet port 40(1) of MFEM 32 to external Ethernet port 269 of expansion device 60.

As depicted in FIG. 3, expansion device 60 is made up of an I/O box controller 261 connected to 2 expansion modules 263 (depicted as expansion modules 263-1, 263-2) via expansion buses 265. As depicted in FIG. 3, expansion device 60 also includes an Ethernet switch 267 having a plurality (4, as depicted) of Ethernet ports to allow for interconnection between an Ethernet port 269, processing circuitry 62, and expansion bus 265. The use of two expansion modules 263-1, 263-2 is by way of example only. In some embodiments, up to four expansion modules 263 may be attached to a single I/O box controller 261.

A first data path 271 proceeds from MFEM 32 to external Ethernet port 269 of expansion device 60, continues through Ethernet switch 270 directly towards expansion bus 265, proceeds through expansion modules 263-1, 263-2, and then connects to an external network 277 via Ethernet port 275 of expansion module 263-2. Thus, an expansion module 263 may be used to expand the number of network connections via path 271. In another embodiment (not depicted), Ethernet port 275 connected to external network 277 may be on I/O box controller 261, e.g., as part of Ethernet switch 270.

A second data path 273 proceeds from MFEM 32 to external Ethernet port 269 of expansion device 60, continues through Ethernet switch 270 to processing circuitry 62, and proceeds on towards expansion modules 263-1, 263-2 via expansion bus 265. Data path 273 may be used to enable storage on an expansion module 263 or to enable data processing by an expansion module with feedback to the MFEM 32.

In an embodiment, an expansion module 263 may be configured to provide a transducer interface (not depicted), e.g., for a temperature transducer. In another embodiment, an expansion module 263 may be configured to provide memory or persistent storage (not depicted) for the expansion device 60. For example, the received information 52 may be recorded to the persistent storage. In another embodiment, an expansion module 263 may be configured to provide special purpose circuitry to perform certain types of calculations or other processing on the received information 52 relating to the measured energy-related parameters 37. In another embodiment, an expansion module 263 may be configured to provide digital inputs (not depicted), e.g., digital status inputs with precision time stamping ability. In another embodiment, an expansion module 263 may be configured to provide digital outputs (not depicted), e.g., dry contact electromechanical or solid state relays. In another embodiment, an expansion module 263 may be configured to provide analog inputs or outputs (not depicted), e.g., 4-20 mA current I/O.

Thus, an improved energy meter has been provided. For example, an improved energy meter 32 may provide three independent ethernet ports 40(1), 40(2), 40(3), capable of connecting to three independent LANs 50(1), 50(2), 50(3) simultaneously. In some embodiments, one or more of the three independent ethernet ports 40 may connect to an expansion box 60 via a LAN connection 50(1). This type of connection may be advantageous because the Precision Time Protocol may be used to synchronize time 66 between the energy meter 32 and the expansion device 60 to a very high degree of precision with a divergence of less than 1 ms, for example. In some embodiments, one or more of the three independent ethernet ports 40 may be configured to receive power via Power over Ethernet to allow for either primary or backup power, reducing the likelihood of unreliable operation of the energy meter 32 when the monitored energy source 36 is fluctuating or offline.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicant makes no admission that such technique, method, apparatus, or other concept is actually prior art under 35 U.S.C. § 102 or 103, such determination being a legal determination that depends upon many factors, not all of which are known to Applicant at this time.

What is claimed is:

1. A multi-function energy meter apparatus comprising:
measurement circuitry configured to measure one or more energy-related parameters; and
three independent ethernet ports communicatively coupled to the measurement circuitry, each independent ethernet port being configured to connect to a respective local area network (LAN) and to communicate the measured energy-related parameters to that LAN.

2. The apparatus of claim 1 wherein one of the three independent ethernet ports is configured to:
connect to an expansion device configured to add additional functionality to the energy meter apparatus; and
communicate information relating to the measured energy-related parameters to the expansion device.

3. The apparatus of claim 2 wherein:
the multi-function energy meter apparatus further includes a local clock; and
the one of the three independent ethernet ports is further configured to synchronize the local clock with a remote clock of the expansion device to a precision within 1 millisecond.

4. The apparatus of claim 2 wherein the one of the three independent ethernet ports is further configured to provide power to the expansion device over a Power over Ethernet (PoE) connection.

5. The apparatus of claim 2 wherein the multi-function energy meter apparatus is configured to send code to the expansion device, the code being configured to expand the additional functionality.

6. The apparatus of claim 1 wherein:
the energy meter apparatus is configured to receive primary power via the measurement circuitry; and
one of the three independent ethernet ports is configured to receive power over a Power over Ethernet (PoE) connection and to provide the received power as backup power for the multi-function energy meter apparatus.

7. The apparatus of claim 1 wherein one of the three independent ethernet ports is configured to receive power over a Power over Ethernet (PoE) connection and to provide the received power as primary power for the multi-function energy meter apparatus.

8. The apparatus of claim 1 wherein communicating the measured energy-related parameters to that LAN includes sending the measured energy-related parameters to that LAN using data link layer (layer 2) communication.

9. A system comprising:
a multi-function energy meter apparatus comprising:
measurement circuitry configured to measure one or more energy-related parameters; and
three independent ethernet ports communicatively coupled to the measurement circuitry; and
three separate ethernet-based local area networks (LANs), each LAN communicatively coupled to a respective one of the three independent ethernet ports;
wherein each independent ethernet port is configured to communicate the measured energy-related parameters to its respective LAN.

10. The system of claim 9 wherein:
the system further comprises an expansion device connected to one of the three independent ethernet ports via one of the ethernet-based LANs;
the expansion device is configured to add additional functionality to the energy meter apparatus; and
the one of the three independent ethernet ports is configured to communicate information relating to the measured energy-related parameters to the expansion device.

11. The system of claim 10 wherein:
the multi-function energy meter apparatus further includes a first clock;
the expansion device includes a second clock; and
the one of the three independent ethernet ports is further configured to synchronize the first clock with the second clock of the expansion device to a precision within 1 millisecond.

12. The system of claim 11 wherein the expansion device is further configured to:
receive a plurality of status input transitions from another device; and
timestamp each of the plurality of status input transitions with reference to the second clock.

13. The system of claim 12 wherein the one of the three independent ethernet ports is further configured to receive the plurality of timestamped status input transitions from the expansion device.

14. The system of claim 10 wherein the one of the three independent ethernet ports is further configured to provide power to the expansion device over a Power over Ethernet (PoE) connection.

15. The system of claim 10 wherein:
the multi-function energy meter apparatus is configured to send code to the expansion device; and
the expansion device is configured to, in response to receiving the code from the multi-function energy meter apparatus, update the additional functionality that it is configured to add to the multi-function energy meter apparatus.

16. The system of claim 9 wherein:
the energy meter apparatus is configured to receive primary power via the measurement circuitry; and
one of the three independent ethernet ports is configured to receive power over a Power over Ethernet (PoE) connection and to provide the received power as backup power for the multi-function energy meter apparatus.

17. The system of claim 9 wherein one of the three independent ethernet ports is configured to receive power over a Power over Ethernet (PoE) connection and to provide the received power as primary power for the multi-function energy meter apparatus.

18. The system of claim 9 wherein communicating the measured energy-related parameters to that LAN includes sending the measured energy-related parameters to that LAN using data link layer (layer 2) communication.
